(19) United States
(12) Patent Application Publication
(10) Pub. No.: US 2006/0126848 A1
(43) Pub. Date: Jun. 15, 2006

(54) Key authentication/service system and method using one-time authentication code

(75) Inventors: Nam Je Park, Gyeongsangnam-do (KR); Ki Young Moon, Daejeon-city (KR); Jong Soo Jang, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/298,209

(22) Filed: Dec. 8, 2005

(30) Foreign Application Priority Data
Dec. 15, 2004 (KR) 10-2004-0106500
Jul. 5, 2005 (KR) 10-2005-0060290

(51) Int. Cl. H04L 9/00

(52) U.S. Cl. 380/277

(57) ABSTRACT

Provided are a key authentication/service system and method using one-time authentication code. In the system and method, a key management client sends a key management server a message requesting transmission of a message for generating authentication code required to request a key management service. Next, the key management server creates a challenge message based on a challenge/response method using the received message. Next, the key management client generates the one-time authentication code using the challenge message and transmits it along with a message requesting a key management service to the key management server. Next, the key management server receives the one-time authentication code from the key management client and checks whether the one-time authentication code is certified to determine whether the key management client has a right to use the key management service. Then, the key management server provides the key management service to the key management client when it is determined that the key management client has a right to use this service.

### BACKGROUND OF THE INVENTION

This application claims the priorities of Korean Patent Application No. 10-2004-106500, filed on Dec. 15, 2004 and Korean Patent Application No. 10-2005-060290, filed on Jul. 5, 2005, in the Korean Intellectual Property Office, the disclosures of which are incorporated herein in their entirety by reference.

1. Field of the Invention

The present invention relates to security protection, and more particularly, to key authentication for web services.

2. Description of the Related Art

An eXtensible Markup Language (hereinafter referred to as “XML”) key management service is a combination of existing public key infrastructure (PKI) services, through which XML application service users receive more convenient key-related services as web services. In the XML key management service, key management (key location information checking, validity checking, key registration, key revocation, key restoration, key re-issuance, etc.) is performed as specified in the XML key management specifications (hereinafter referred to as “XKMS”) based on XML messages.

When requesting a registration service for an XML key, a client exchanges authentication code, which is to be used as a secret key, with an XML key management system. The authentication code is exchanged according to a method which is different from the XKMS. For instance, the authentication code is exchanged through a telephone, e-mail, or face-to-face contact. A secret for authentication, which is shared within a limited range, is required to authenticate an XML key registration service message. A message requesting key registration from a key management client is signed using authentication code, and the XML key management system checks the authentication code to verify authentication of the message.

Conventionally, authentication code is generated from a random number or expressed as a stream of characters such as a password and a set of characters, and provided using a MAC function. However, in this case, since packet data exchanged via a communication channel is a password, the password is very likely to be hacked by eavesdropping over the communication channel.

Although various XML key management systems have recently been developed, a technical apparatus and method that provide a solution to security problems caused when key registration messages are exchanged, have yet to be developed.

### SUMMARY OF THE INVENTION

The present invention provides a system for requesting a key authentication/service using one-time authentication code, the system being capable of solving security problems caused when exchanging key registration messages in an XML key management system, and a system for managing a key authentication/service using one-time authentication code as per a request for a key authentication/service.

The present invention also provides a method of requesting a key authentication/service using one-time authentication code through the above systems, and a method of managing a key authentication/service using one-time authentication code.

According to an aspect of the present invention, there is provided a system for requesting a key authentication/service using one-time authentication code, the system including a key management message processor requesting a message for generating authentication code required to make a request for a key management service, and creating a message which requests the key management service; and a security processor creating one-time authentication code according to a predetermined method, using a challenge message received from the key management processor as a reply to the message for generating authentication code.

According to another aspect of the present invention, there is provided a system for managing a key authentication/service using one-time authentication code, the system including a service request receiving unit receiving a message requesting creation of authentication code, an one-time authentication code, and a message requesting a key management service; a key management message interpreting unit interpreting the message requesting creation of the authentication code, the message being received from the service request receiving unit, and receiving the one-time authentication code; a message authentication processor creating a challenge message based on a challenge/response method using the message interpreted by the key management message interpreting unit; interpreting the one-time authentication code, which is received as a reply to the challenge message, according to a predetermined method corresponding to a method used to generate the one-time authentication code; and determining whether the request for the key management service is certified; and a key management service unit performing a key management service according to the message requesting the key management service when the message authentication processor determines that the request for the key management service is certified, or requesting a server, which includes a predetermined certification agency, to provide a service corresponding to the key management service.

According to another aspect of the present invention, there is provided a method of requesting a key authentication/service using one-time authentication code, the method comprising requesting transmission of a message for generating authentication code to request a key management service; receiving a response message to the request, and creating the one-time authentication code using the response message; and requesting the key management service by transmitting the one-time authentication code together with a message requesting the key management service.

According to another aspect of the present invention, there is provided a method of managing a key authentication/service using one-time authentication code, the method comprising receiving a request for transmission of a message for generating authentication code required to request a key management service; generating a challenge message using the message requested in (a) based on a challenge/response method, and transmitting the challenge message in response to the request for transmission of the message; receiving a message requesting a key management service along with the one-time authentication code generated using the challenge message; interpreting the one-time authentication code to determine whether the one-time authentication code is certified, and verifying the request for the key management service; and providing the key management service when the request for the key management service is verified.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a block diagram illustrating a system in which a key management client that is a system requesting a key authentication/service using one-time authentication code, and a key management server that is a system managing the key authentication/service using one-time authentication code, are connected, according to an embodiment of the present invention;

FIG. 2 is a block diagram illustrating internal constructions of a key client that is a system requesting a key authentication/service using one-time authentication code, and a key management server that is a system for managing the key authentication/service using one-time authentication code, according to an embodiment of the present invention; and

FIG. 3 is a flowchart illustrating a method of requesting a key authentication/service using one-time authentication code and managing the key authentication/service using one-time authentication code as per the request, according to an embodiment of the present invention.

### DETAILED DESCRIPTION OF THE INVENTION

Hereinafter, exemplary embodiments of the present invention will be described in detail with reference to the accompanying drawings.

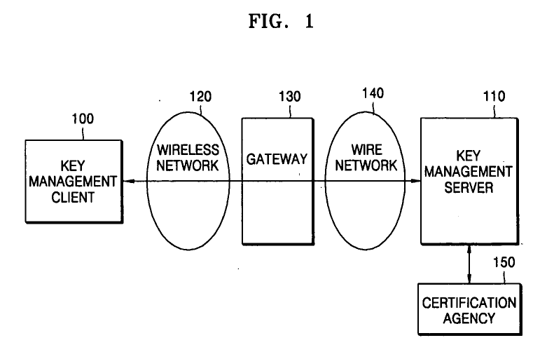

FIG. 1 is a block diagram illustrating a system in which a key management client 100 that is a system requesting a key authentication/service using one-time authentication code, and a key management server 110 that is a system managing the key authentication/service using one-time authentication code are combined, according to an embodiment of the present invention.

In this disclosure, for convenience of explanation, a key to be used for a key authentication/service according to the present invention is limited to an XML key. It would be apparent to those of ordinary skill in the art that the present invention is applicable to an authentication/service of any key, not necessarily an XML key.

The system of FIG. 1 includes the key management client 100 that is a system that is connected to a certification agency 150 that issues and revokes a certificate via a gateway 130 via either a wire network 140 or a wireless network 120, and that requests an XML key management service; and the key management server 110 that is a system that receives a request for a service from the key management client 100 and provides the service directly to the key management client 100, or requests the certification agency 150 to provide an XML key and performs key management.

When the key management client 100 requests the key management server 110 to provide a message required to generate authentication code so as to receive a key management service, the key management server 110 creates a challenge message based on a challenge/response method and transmits it to the key management client 100. The key management client 100 generates one-time authentication code using the received challenge message according to a predetermined method, selects a desired key management service, and transmits the one-time authentication code together with a message requesting the selected key management service to the key management server 110. Then, when it is verified that the key management client has a right to use the selected key management service, the key management server 110 checks the received one-time authentication code, and performs key management according to the type of the key management service or requests the certification agency 150 to provide a service corresponding to the key management service.

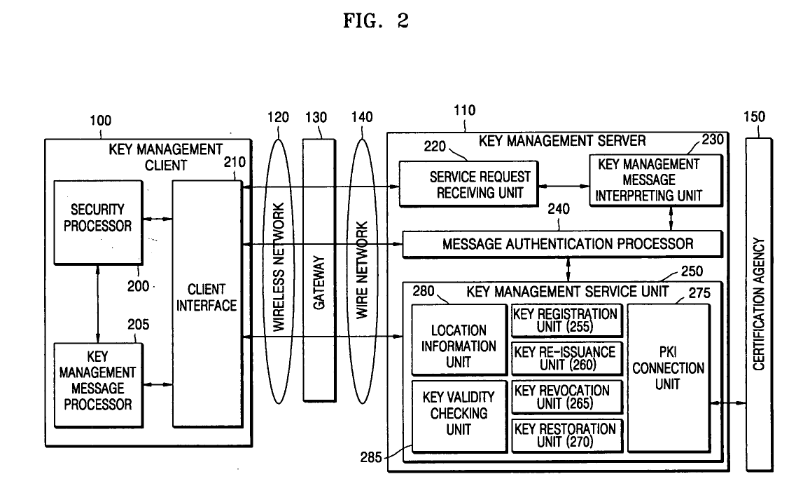

FIG. 2 is a block diagram illustrating the internal constructions of the key management client 100 that is a system requesting a key authentication/service using one-time authentication code, and the key management server 110 that is a system managing the key authentication/service using one-time authentication code, according to an embodiment of the present invention. In FIG. 2, elements that have the same constructions as those of FIG. 1 are described with the same reference numerals used to indicate the elements of FIG. 1.

The key management client 100 includes a key management message processor 205 that requests the key management server 110 to provide a message required to generate authentication code so as to receive a key management service, and transmits a message requesting a desired key management service together with one-time authentication code to the key management server 110, using a reply to the received message; a security processor 200 that generates the one-time authentication code according to a predetermined method, using a challenge message transmitted from the key management server 110 in response to the request for the message required to generate the authentication code from the key management message processor 205; and a client interface 210 that provides an interface for exchange of data between the key management client 100 and the key management server 110.

Also, the key management server 110 includes a service request receiving unit 220, a key management message interpreting unit 230, a message authentication processor 240, and a key management service unit 250. The service request receiving unit 220 receives, from the key management client 100, the message required to generate the authentication code, the one-time authentication code, and the message requesting the desired key management service. The key management message interpreting unit 230 interprets the messages received from the service request receiving unit 220 and receives and transmits the one-time authentication code from the service request receiving unit 220, as per the request from the service request receiving unit 220. The message authentication processor 240 receives the interpreting result from the key management message interpreting unit 230, creates the challenge message based on the challenge/response method using the interpreting result, receives the one-time authentication code as a reply to the challenge message from the key management message interpreting unit 230, determines whether the right to use the designated key management service is authenticated, using a method corresponding to the method used to generate the authentication code, receives the message requesting the key management service transmitted together with the authentication code, and transmits them to the key management service unit 250. The key management service unit 250 receives the message requesting the key management service from the message authentication processor 240, and performs key management as specified in the received message or requests the certification agency 150 to provide a service corresponding to the key management service.

The key management service unit 250 includes a key registration unit 255 that registers a user public key of the key management client 100, a key revocation unit 265 that revokes a key, a key re-issuance unit 260 that reissues the key, a key restoration unit 270 that restores the key, and a public key infrastructure (PKI) connection unit 275 that is connected to the certification agency 150 to receive and transmit the content of the key management service.

The key management service unit 250 further includes a key location information unit 280 that detects public key information and transmits it to the key management client 100 when the desire of the key management client 100 to receive the public key information is described in the message requesting the key management service transmitted from the key management client 100 to the key management server 110; and a key validity checking unit 285 that checks whether a public key detected by the key location information unit 280 is valid.

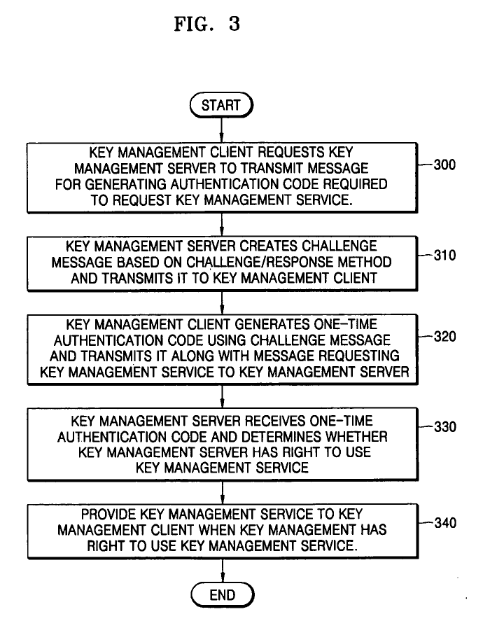

FIG. 3 is a flowchart illustrating a method of requesting a key authentication/service using one-time authentication code and managing the authentication/service using one-time authentication code as per the request, according to an embodiment of the present invention. The method of FIG. 3 is performed by the system illustrated in FIG. 1 or 2.

The method of FIG. 3 is to provide an XML key management service using one-time authentication code, the method being performed by the system, illustrated in FIG. 1 or 2, which includes the key management client 100 connected to the certification agency 150 via the wire network 140 or the wireless network 120 and that requests an XML key management service; and the key management server 110 that provides the service directly to the key management client 100, or requests the certification agency 150 to provide an XML key and performs key management. In the method, the key management client 100 requests the key management server 110 to provide a message required to generate authentication code so as to receive a key management service (operation 300). Next, the key management server 110 creates a challenge message based on a challenge/response method and transmits it to the key management client 100 (operation 310). Next, the key management client 100 generates the one-time authentication code using the challenge message and transmits it together with a message requesting the key management service to the key management server 110 (operation 320). Next, the key management server 110 receives the one-time authentication code from the key management client 100, and determines whether the one-time authentication code is authenticated so as to determine whether the key management client 100 has a right of use of the key management service (operation 330). Next, when it is determined that the key management client 100 has a right to use the key management service, the key management server 110 provides the key management service to the key management client 100 (operation 340).

The method of FIG. 3 will now be described in greater detail with reference to FIG. 2. In this disclosure, a key used in an XML key registration service must be understood as a certified key to be used as a secret key, that is, the key indicates either the secret key or the certified key.

As described above, when a key is disclosed, an XML key service is vulnerable to security problems and thus requires a solution to the security problems. As the solution, it is determined if the client has a right to request a key service prior to requesting a server to provide the service.

The key service includes key registration, key re-issuance, key revocation, key restoration, etc. In order to receive the service, the key management client 100 requests the key management server 110 to provide a message for generating authentication code required in a key management service (operation 300). Operation 300 is performed by the key management message processor 205.

The request for the basic data is sequentially transmitted to the client interface 210, the wireless network 120, the gateway 130 that connects the wireless network 120 and the wireless network 140, the wire network 140, and the service request receiving unit 220.

The wireless network 120, the gateway 130, and the wire network 140 are examples of paths via which data is transmitted, that is, the types of communication networks employed in the present invention are not limited. Also, the communication networks allow web-based connections, thereby realizing a web service-based authentication/service system and method according to the present invention.

The key management message interpreting unit 230 interprets the request received from the service request receiving unit 220 and transmits the interpreting result to the message authentication processor 240. Since the key management client 100 requests the message required to generate the authentication code, the message authentication processor 240 generates a challenge message based on a challenge/response method and transmits it to the key management client 100 (operation 310).

It is preferable that a message requesting a key management service, which is transmitted from the key management client 100, is signed using predetermined authentication code, and the key management server 110 checks whether the message requesting the key management service is signed using the predetermined authentication code to verify authentication of the message.

A method of creating a challenge message based on the challenge/response method is obvious to those of ordinary skill in both the field of XML, i.e., the technical field to which the present invention belongs, and therefore, a description thereof will be omitted.

The challenge message is transmitted to the security processor 200 via the client interface 210. The security processor 200 creates one-time authentication code according to a predetermined method, using the challenge message. Various encryption methods may be used as the predetermined method.

The one-time authentication code may be generated and transmitted as follows:

1) The security processor 200 generates an algorithm value S(1) from a random number and given identification. Likewise, a value S(2) is generated from another random number and identification;

2) One-time code values U(1), U(2) and U(3) are computed using the values S(1) and S(2); and

3) The computed values U(1), U(2), and U(3) are transmitted according to the challenge/response method.

An encryption method used by the security processor 200 is predetermined between the security processor 200 and the key management server 110, particularly, the message authentication processor 240. That is, the challenge message used in the encryption method and the encryption method are disclosed to both the key management client 100 and the key management server 110 beforehand. Thus, the message authentication processor 240 is capable of decrypting the authentication code created by the security processor 200.

The key management message processor 205 generates a message describing the key management service to be received from the key management server 110, and transmits the message together with the authentication code to the key management server 110 (operation 320).

Likewise in operation 300, the service request receiving unit 220 receives the message and the authentication code, and the key management message interpreting unit 230 interprets the message so that the key management client 100 can receive the key management service.

The message authentication processor 240 decodes the received one-time authentication code to determine whether the key management client 100 has a right to request the key management service (operation 330).

When it is determined that the key management client 100 has a right to request the key management service, the message authentication processor 240 provides the key management service unit 250 with information regarding the key management service and the key management client 100 requesting the key management service. Since there may be a plurality of key management clients that request the key management service, the information regarding the key management client 100 is also transmitted to the key management service unit 250 so as to identify the key management client 100 from the key management clients.

The one-time authentication code is literally one-time code, and thus, new one-time authentication code is generated for a subsequent service.

Operation 340 in which the key management service unit 250 of the key management server 110 provides the key management service according to the type of the key management service requested by the key management client 100, will now be described in greater detail.

The key registration unit 255 registers a client public key. In this case, for key registration, an XML key may be generated by the key management client 100 or the key management server 110.

When the key management client 100 generates the XML key, the key management client 100 must prove that it has a pair of a private key and a public key through a process of certifying ownership of the private key.

This process may be performed through certification of ownership. An example of certification of ownership is as follows:

1) When a client is connected to a server, the server generates a challenge value and transmits it to the client;

2) The client signs the challenge value using its private key and transmits a sign value and a request for certification of ownership of the private key to the server;

3) The key management server 110 obtains a hash value (1) by extracting a public key from the request and decoding the sign value using the public key;

4) The server performs a hash operation on a random value that the server provides to compute a hash value (2); and

5) The hash values (1) and (2) are compared to perform certification of ownership.

When the key management server 110 generates the XML key, the key management server 110 may generate a pair of a public key and a private key to be allocated to the key management client 100. The key management server 110 encrypts and stores the private key of the key management client 100 using its password, and encrypts the encrypted private key using one-time authentication code and provides the encrypting result to the key management client 100, when the key management client 100 requests the private key.

The XML key registration service unit 250 requests the key registration service via the PKI connection unit 275 again, using a PKI method or the like. A non-synchronous message may be used to perform the key registration service.

When the key management client 100 generates a pair of a private key and a public key for the key registration service, it is preferable that the message transmitted in operation 320 includes a request for key registration, the one-time authentication code proves that the key management client 100 holds the pair of the private key and the public key, the message authentication processor 240 checks whether the one-time authentication code proves that the key management client 100 holds the pair of the private key and the public key, and the request for key registration from the key management client 100 is transmitted to the certification agency 150 in operation 340.

When the key management server 110 generates the XML key, the message authentication processor 240 preferably encrypts and stores a key corresponding to the key management client 100 using a predetermined password. The message transmitted in operation 320 preferably includes a request for key registration. In operation 340, the message authentication processor 240 preferably decrypts the encrypted key, encrypts it using the one-time authentication code transmitted in operation 320 according to a predetermined method, and provides the encrypting result to the key management client 100. The key registration unit 255 preferably requests the certification agency 150 to provide a key registration service that the key management client 100 requests, via the PKI connection unit 250.

Certification of ownership of a private key is also performed when requesting the certification agency 150 to provide a message service.

The predetermined encryption method may be a general encryption technique.

The key re-issuance unit 260 re-issues a key of a user of the key management client 100. The user can receive a key, the validity term of which is extended through key re-issuance. The operation of the key re-issuance unit 260 is similar to that of the key registration unit 255. The key management server 110 and the key management client 100 exchange the one-time authentication code to be used as a secret key. A message requesting a key re-issuance service, which is transmitted from the key management client 100, is signed using the one-time authentication code, and certification of ownership is used to prove that the key management client 100 holds the private key. The key re-issuance unit 260 requests the certification agency 150 again to provide the key re-issuance service via the PKI connection unit 275. Likewise, a non-synchronous message is used to perform the key re-issuance service.

For the key re-issuance service, it is preferable that the message requesting the key management service, which is transmitted from the key management client 100 to the key management server 110, includes a request for re-issuance of the previously issued key; the message authentication processor 240 checks the request for the re-issuance and the one-time authentication code to determine whether the key management client 100 has the private key; and the key re-issuance unit 260 requests the certification agency 150 to provide the key re-issuance service that the key management client 100 requests, via the PKI connection unit 275.

That the message authentication unit 240 checks the one-time authentication code to determine whether the key management client 100 has the private key, has substantially the same meaning as whether the key management client 100 has a right to request the key re-issuance service, that is, a right to extend the validity term of the key.

The key revocation unit 265 revokes the key assigned to the user of the key management client 100. The user can revoke a key, the validity term of which has yet to expire, using the key revocation unit 265. For a key revocation service, first, it is determined whether the key management client 100 has a right to revoke the key. The one-time authentication code is used to determine whether the key management client 100 has a right to revoke the key.

Prior to a request for the key revocation service, the one-time authentication code is exchanged between the key management client 100 and the key management server 110, and a message requesting this service is signed using the one-time authentication code. The key management server 110 checks the signature of the message to determine whether the request for the key revocation service is right. In the key revocation service, information of the key is canceled from a key storage unit and a request for revoking a certificate of the key is transmitted to the certification agency 150 via the PKI connection unit 275. The key revocation service is performed in the form of a non-synchronous message.

The message requesting the key revocation service, which is transmitted from the key management client 100 to the key management server 110, preferably contains a request for revocation of the key that has previously been issued and the validity term of which has yet to expire. The message authentication processor 240 preferably checks the one-time authentication code to determine whether the key management client 100 has a right to revoke the key, and deletes the information regarding the key of the key management client 100. The key revocation unit 265 preferably requests the certification agency 150 to provide the key revocation service for the key management client 100 via the PKI connection unit 275.

The key restoration unit 270 restores the private key of the key management client 100. A key restoration service is performed only when a pair of a private key and a public key are generated by the key management server 110, not the key management client 100.

Like the other services, the key restoration service is also performed only when the one-time authentication code is exchanged between the key management server 110 and the key management client 100. The key management client 100 signs a message requesting the key restoration service using the one-time authentication code and transmits it to the key management server 110. Then, the key management server 110 verifies authentication of the message and performs key restoration.

To prevent unlimited key restoration, a number of times that key restoration is performed must be limited to a predetermined number. When the number of times that key restoration is performed exceeds the predetermined number, a private key of a user is deleted from a key data storage device. Unlike the other services, the key restoration service is individually performed without communicating with the certification agency 150 via the PKI connection unit 275.

Accordingly, a message requesting key restoration, which is transmitted from the key management client 100 to the key management server 110, preferably includes a request for restoration of the key issued by the key management client 100. The message authentication processor 240 preferably checks the one-time authentication code to determine whether the key management client 100 has a right to restore the key, and provides the key to the key management client 100.

The number of times that key restoration is performed, is set to a predetermined number so that a number of times that the key restoration service is provided cannot exceed the predetermined number. When the key restoration service is provided the predetermined number of times, the private key of the key management client 100 is preferably canceled.

The key location information unit 280 detects a public key as per a request from the key management client 100. The key management client 100 may obtain a public key and a certificate of ownership through a key location information service if required.

The key validity checking unit 285 verifies whether the public key that the key management client 100 requests is valid.

As described above, in key authentication according to an embodiment of the present invention, the previously used one-time authentication code can never be used again, and new one-time authentication code is generated from a random number different from the random number used to generate the previously used one-time authentication code, for example, and is used for subsequent key authentication. Therefore, even if authentication code is disclosed, new authentication code is used for the subsequent key authentication, thereby preventing unauthorized authentication caused by hacking.

Although the present invention has been described with respect to the XML key, it is obvious that the present invention is applicable to various fields of key authentication.

According to the present invention, a key management client requests a key management server to provide a message required to generate authentication code so as to receive a key management service. The key management server generates a challenge message using the message based on a challenge/response method. Next, the key management client creates one-time authentication code using the challenge message and transmits it along with a message requesting the key management service to the key management server. Then, the key management server receives the one-time authentication code from the key management client, checks whether the one-time authentication code is certified to determine whether the key management client has a right to use the key management service, and provides the key management service to the key management client when it is determined that the key management client has a right to use this service. Accordingly, even if the one-time authentication code is disclosed via a network, since the code is used only once, it is possible to prevent unauthorized authentication using the disclosed code. In particular, key authorization according to the present invention does not require additional hardware for authentication and allows use of a message without any processing, thereby increasing security for the XML key management service without installing additional devices to the key management server.

It would be obvious to those of ordinary skill in the art that each of the above operations of the present invention may be embodied by hardware or software, using general program techniques.

Also, some of the above operations of the present invention may be embodied as computer readable code in a computer readable medium. The computer readable medium may be any recording apparatus capable of storing data that is read by a computer system, e.g., a read-only memory (ROM), a random access memory (RAM), a compact disc (CD)-ROM, a CD-rewritable (RW), a magnetic tape, a floppy disk, a hard disk drive (HDD), an optical data storage device, a magnetic-optical storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A system for requesting a key authentication/service using one-time authentication code, comprising:
a key management message processor requesting a message for generating authentication code required to make a request for a key management service, and creating a message which requests the key management service; and
a security processor creating one-time authentication code according to a predetermined method, using a challenge message received from the key management processor as a reply to the message for generating authentication code.

2. The system of claim 1, wherein the message requesting the key management service is signed using an authentication code generated according to a public key/private key-based predetermined method.

3. A system for managing a key authentication/service using one-time authentication code, comprising:
a service request receiving unit receiving a message requesting creation of authentication code, a one-time authentication code, and a message requesting a key management service;
a key management message interpreting unit interpreting the message requesting creation of the authentication code, the message being received from the service request receiving unit, and receiving the one-time authentication code;
a message authentication processor creating a challenge message based on a challenge/response method using the message interpreted by the key management message interpreting unit; interpreting the one-time authentication code, which is received as a reply to the challenge message, according to a predetermined method corresponding to a method used to generate the one-time authentication code; and determining whether the request for the key management service is certified; and
a key management service unit performing a key management service according to the message requesting the key management service when the message authentication processor determines that the request for the key management service is certified, or requesting a server, which includes a predetermined certification agency, to provide a service corresponding to the key management service.

4. The system of claim 3, wherein when the received message requesting the key management service is signed using predetermined authentication code, it is checked whether the received message is signed using the predetermined authentication code according to a predetermined method to verify authentication of the received message, the predetermined method including a public key/secret key-based method.

5. The system of claim 3, wherein the received message requesting the key management service comprises requests for key registration, key re-issuance, key revocation, and key restoration,
the key management message interpreting unit interprets the key management service specified in the received message, and transmits the interpreting result to the message authentication processor, and
the key management service unit performs registration, revocation, re-issuance, and restoration of a user public key of a client which requests the key management service, or exchanges content of the key management service with the server to provide a service corresponding to the key management service.

6. The system of claim 3, wherein the key management service unit comprises:
a key location information unit detecting information regarding a public key of the client which requests the key management service and transmitting the information to the client, when the message requesting the key management service, which is received from the client, includes a request for the information regarding the public key of the client; and
a key validity checking unit verifying whether the public key detected by the key location information unit is valid.

7. The system of claim 3, wherein when the client requesting the key management service generates a pair of a public key and a private key, key registration is performed using one of:
the client generating the one-time authentication code including information that the client holds the private key and the public key, and transmitting the one-time authentication code to the message authentication unit so that the message authentication unit recognizes the information; and
the message authentication processor encrypting and storing a private key of the client using a predetermined password, and providing the encrypted private key to the client when the client requests the private key, and
the key management service unit requests the server to provide a key registration service to the client requesting the key management service.

8. The system of claim 3, wherein the message requesting the key management service, which is received from the client, comprises a request for re-issuance of a previously issued key,
the message authentication processor checks the request for the re-issuance of the previously issued key and the one-time authentication code to determine whether the client has the private key, and
the key management service unit requests the server to provide a corresponding key re-issuance service to the client requesting the key management service.

9. The system of claim 3, wherein the message requesting the key management service, which is received from the client, comprises a request for revocation of a key which has previously been issued and a validity term which does not expire,
the message authentication processor checks the one-time authentication code to determine whether the client has a right to revoke the key, and deletes information regarding the key when it is determined that the client has the right to revoke the key, and
the key management service unit requests the server to provide a corresponding key revocation service to the client requesting the key management service.

10. The system of claim 3, wherein the message requesting the key management service, which is received from the client, comprises a request for restoration of a key issued by the client, and
the message authentication processor checks the one-time authentication code to determine whether the client has a right to restore the key and provides the key to the client when it is determined that the client has the right to restore the key.

11. The system of claim 3, wherein a number of times that restoration of the key has been limited to a predetermined number so that that a number of times that a key restoration service is performed does not exceed the predetermined number, and
when the key restoration service is performed the predetermined number of times, the key of the client is canceled.

12. A method of requesting a key authentication/service using one-time authentication code, comprising:
(a) requesting transmission of a message for generating authentication code to request a key management service;
(b) receiving a response message to the request, and creating the one-time authentication code using the response message; and
(c) requesting the key management service by transmitting the one-time authentication code together with a message requesting the key management service.

13. The method of claim 12, wherein when the message requesting the key management service is generated according to a public key/private key-based method, the message comprises a request for key registration, and the one-time authentication code comprises evidence that the message is generated using a pair of a public key and a private key.

14. A method of managing a key authentication/service using one-time authentication code, comprising:
(a) receiving a request for transmission of a message for generating authentication code required to request a key management service;
(b) generating a challenge message using the message requested in (a) based on a challenge/response method, and transmitting the challenge message in response to the request for transmission of the message;
(c) receiving a message requesting a key management service along with the one-time authentication code generated using the challenge message;
(d) interpreting the one-time authentication code to determine whether the one-time authentication code is certified, and verifying the request for the key management service; and
(e) providing the key management service when the request for the key management service is verified.

15. The method of claim 14, wherein, when the message transmitted in (c) comprises a request for key registration and the one-time authentication code includes evidence that a client requesting key registration holds a pair of a secret key and a public key, (e) comprises requesting a predetermined certification agency to provide a request for a key registration service based on the secret key and the public key.

16. The method of claim 14, wherein, when the message transmitted in (c) comprises a request for re-issuance of a previously registered key and the one-time authentication code comprises an evidence that a client requesting the re-issuance of the previously registered key has a private key, (e) comprises requesting a predetermined certification agency to provide a key re-issuance service to the client.

17. The method of claim 14, wherein, when the message transmitted in (c) comprises a request for revocation of a key which has previously been issued and a validity term which does not expire and the one-time authentication code comprises content allowing determination as to whether the client has a right to revoke the key, (e) comprises deleting the key corresponding to the client and requesting a predetermined certification agency to provide a key revocation service to the client.

18. The method of claim 14, wherein, when the message transmitted in (c) comprises a request for restoration of a key issued to the client and the one-time authentication code comprises content allowing determination as to whether the client has a right to restore the key, (e) comprises providing a client requesting the restoration of the key with a key which corresponds to the client and has been stored.
